(19) United States
(12) Patent Application Publication
(10) Pub. No.: US 2024/0345381 A1
(43) Pub. Date: Oct. 17, 2024

(54) MANAGING OPTICAL BEAM STEERING

(71) Applicant: Analog Photonics LLC, Boston, MA (US)

(72) Inventor: Michael Robert Watts, Hingham, MA (US)

(73) Assignee: Analog Photonics LLC, Boston, MA (US)

(21) Appl. No.: 18/632,438

(22) Filed: Apr. 11, 2024

Related U.S. Application Data
(60) Provisional application No. 63/459,033, filed on Apr. 13, 2023.

(51) Int. Cl. G02B 26/08; G02F 1/29; G02F 1/313

(52) U.S. Cl. CPC G02B 26/0816; G02F 1/292; G02F 1/3136

(57) ABSTRACT

An electronically steerable optical source comprises a photonic array comprising a plurality of optical antennas arranged along a line, and circuitry configured to control steering of a beam about a first axis substantially perpendicular to the line. A steering range over which the steering of the beam is limited is characterized by first and second vectors at extrema of the steering range. A mounting structure is rotatably attached to a base structure, with the electronically steerable optical source rigidly mounted to the mounting structure. A rotation controller is configured to rotate the mounting structure with respect to the base structure about a second axis by at least 180 degrees, where the electronically steerable optical source is oriented on the mounting structure such that (1) the second axis is not parallel to the line, and (2) the first vector is substantially parallel to the second axis.

### CROSS-REFERENCE TO RELATED APPLICATION(S)

This application claims priority to and the benefit of U.S. Provisional Application Ser. No. 63/459,033, entitled “MANAGING OPTICAL BEAM STEERING,” filed Apr. 13, 2023, the entire disclosure of which is hereby incorporated by reference.

### TECHNICAL FIELD

This disclosure relates to managing optical beam steering.

### BACKGROUND

Some photonic integrated circuits (PICs) can enable beam steering, for example, by using one or more optical phased arrays. Some optical phased arrays have a linear distribution, along a line called the array direction, of optical antennas (also referred to as optical emitters). Beam steering about a first axis perpendicular to the array direction can be achieved by modifying the relative phase shifts in phase shifters that are optically coupled to each of the optical antennas. Such beam steering can be performed in a solid-state manner, rapidly, and potentially with random-access, but may be limited to one dimension.

One application of beam steering can be found in some example LiDAR systems, where an optical beam from an optical source can be transmitted using an optical phased array to target one or more object at a given distance and the light backscattered from the target objects can be collected using another optical phased array. Various techniques, such as modulation and/or time of flight, can be used to determine the distance to the target objects based on information associated with a detection event. The optical source (e.g., a laser) used in such a system may provide an optical beam that has a narrow linewidth and a peak wavelength that falls in a particular range (e.g., between about 100 nm to about 1 mm, or some subrange thereof), also referred to herein as simply “light”. Another application in which beam steering may be relevant is in free-space optical communications.

### SUMMARY

In one aspect, in general, an apparatus comprises: an electronically steerable optical source comprising a photonic array comprising a plurality of optical antennas arranged along a line, and circuitry configured to control steering of a beam transmitted from or received by one or more of the optical antennas about a first axis, where (1) the first axis is substantially perpendicular to the line, and (2) a steering range over which the steering of the beam is limited is characterized by a first vector at one extremum of the steering range and a second vector at another extremum of the steering range; a base structure; a mounting structure rotatably attached to the base structure, with the electronically steerable optical source rigidly mounted to the mounting structure; and a rotation controller configured to rotate the mounting structure with respect to the base structure about a second axis by at least 180 degrees, where the electronically steerable optical source is oriented on the mounting structure such that (1) the second axis is not parallel to the line, and (2) the first vector is substantially parallel to the second axis.

Aspects can include one or more of the following features.

The apparatus further comprises an optical element configured to transfer the beam to or from one or more of the optical antennas and configured to at least partially collimate the beam.

The optical element comprises one or more reflective curved surfaces configured to collimate the beam.

The collimating occurs along a first direction associated with the beam.

The collimating also occurs along a second direction perpendicular to the first direction associated with the beam.

The optical element is cylindrical and the collimating occurs only along the first direction associated with the beam.

The photonic array is an optical phased array.

The circuitry configured to control steering of the beam comprises one or more phase shifters.

The one or more phase shifters are voltage-controlled.

The electronically steerable optical source further comprises two or more modulators, each associated with a different subset of one or more of the optical antennas, configured to encode information in the beam based at least in part on one or more of: a wavelength of the beam, an aperture size associated with the optical phased array, or an angle of steering of the beam about the first axis.

The two or more modulators are each configured to encode information in the beam by modifying at least one of a phase, frequency, amplitude, or polarization associated with the beam.

The optical antennas comprise grating antennas on a photonic integrated circuit.

The optical antennas comprise portions of at least one facet of a photonic integrated circuit, and each portion is coupled to a respective waveguide in the photonic integrated circuit.

The photonic array is a photonic switched array, and the circuitry configured to control steering of a beam transmitted from or received by one or more of the optical antennas comprises one or more optical switches.

The one or more optical switches are voltage-controlled.

The optical switches are configured to optically couple a subset of the optical antennas and an optical port of the photonic switched array.

The apparatus further comprises an optical steering element configured to convert a lateral displacement between the beam and a center of the optical steering element into an angular displacement.

The optical steering element is further configured to collimate the beam.

The apparatus further comprises a first optical element and a second optical element configured to expand the beam.

The rotation controller is configured to rotate the mounting structure with respect to the base structure about the second axis by at least 360 degrees.

In another aspect, in general, a method for steering a beam transmitted from or received by one or more optical antennas of a plurality of optical antennas, of at least one photonic array, arranged along a line comprises: controlling steering of the beam about a first axis based on electronic control of the photonic array, The first axis is substantially perpendicular to the line, and a steering range over which the steering of the beam is limited is characterized by a first vector at one extremum of the steering range and a second vector at another extremum of the steering range; and controlling steering of the beam about a second axis based on rotation of a mounting structure on which an electronically steerable optical source comprising the photonic array is rigidly attached, The mounting structure defines a second axis, the electronically steerable optical source is oriented on the mounting structure such that (1) the second axis is not parallel to the line, and (2) the first vector is substantially parallel to the second axis, and the mounting structure is rotated with respect to a base on which the mounting structure is rotatably attached about the second axis by at least 180 degrees.

Aspects can have one or more of the following advantages.

In some examples, the rotatable photonic systems (RPSs) disclosed herein can be used to emit or receive optical beams, or probe and measure environments or regions, over a wide range of angles (i.e., a large field of view). In some example RPSs, the manner in which a photonic integrated circuit (PIC) is oriented on a mounting structure can result in a large field of view that efficiently augments a limited steering range by providing rotation about an axis that depends on that steering range. Additionally, in some examples an RPS can perform beam-steering in a substantially wavelength-independent manner that is beneficial for applications where there is a non-negligible bandwidth of light being transmitted and/or received by the RPS (e.g., in free-space optical communications). RPSs may also replace other mechanically-based steering devices, resulting in a lower mass and a more compact optical aperture with lower inertia. As a result, further benefits of the RPS may include reduced size, weight, and power consumption.

Other features and advantages will become apparent from the following description, and from the figures.

### BRIEF DESCRIPTION OF THE DRAWINGS

The disclosure is best understood from the following detailed description when read

in conjunction with the accompanying drawings. It is emphasized that, according to common practice, the various features of the drawings are not to-scale. On the contrary, the dimensions of the various features are arbitrarily expanded or reduced for clarity.

FIG. 1A is a schematic diagram of an example optical phased array.

FIG. 1B is a schematic diagram of an example photonic switched array.

FIG. 1C is a schematic diagram of an example photonic switched array system.

FIG. 1D is a schematic diagram of a portion of an example photonic integrated circuit.

FIG. 2 is a schematic diagram of an example photonic array transceiver system.

FIG. 3A is a schematic diagram of an example rotatable photonic system.

FIG. 3B is a schematic diagram of an example rotatable photonic system.

FIG. 3C is a schematic diagram of an example field of view.

FIG. 3D is a schematic diagram of an example field of view.

FIG. 3E is a schematic diagram of an example field of view.

FIG. 3F is a schematic diagram of an example collimation configuration.

FIG. 3G is a schematic diagram of an example beam expansion configuration.

FIG. 4 is a schematic diagram of an example photonic integrated circuit.

FIG. 5 is a schematic diagram of an example optical phased array.

FIG. 6 is a schematic diagram of an example optical phased array.

### DETAILED DESCRIPTION

Photonic integrated circuits (PICs) can enable beam steering using optical phased arrays, photonic switched arrays, or other on-chip techniques, collectively referred to herein as photonic arrays. However, two-dimensional solid-state beam steering can be challenging for PIC-only architectures. In some examples, the second dimension of beam steering can be accessed by using wavelength tuning (also referred to as wavelength-based beam steering) combined with a grating-based optical antenna. In general, there are applications that do not allow for wavelength-based beam steering, for example due to the application being constrained to a fixed wavelength laser or due to the inability to couple wavelength with beam steering. In free-space data communication, for example, there can be two potential issues that arise when attempting to couple wavelength with beam steering. The first issue can be on the transmit side, where a modulated optical signal with an associated optical bandwidth (i.e., comprising a range of wavelengths) produces a smeared beam due to the different wavelengths present in the modulated optical signal, thereby resulting in different beam steering angles. The second issue can be on the receive side, where wavelength-based steering may lead to a physical constraint of how the receiver may need to be rotated in space based on the wavelength to be received. The second issue can be present for many applications where a device with a wavelength-based beam steering is utilized as a receiver.

Disclosed herein is a rotatable photonic system (RPS) comprising 1D-beam-steering (e.g., by a photonic array) and azimuthal-beam-steering (e.g., by an axially-rotatable gimbal) that collectively perform 2D-beam-steering. In some examples, the RPS can perform 2D-beam-steering that allows light emitted from one or more photonic arrays to cover the volume of an entire hemisphere. In other examples, the 2D-beam-steering may cover a volume that is a portion of the volume of an entire hemisphere. For example, the 2D-beam-steering may cover a conical volume, or it may cover a portion of the volume of an entire hemisphere, where a spherical conical volume is removed from the hemisphere. Furthermore, the 2D-beam-steering may cover a portion of a spherical conical volume, wherein a smaller spherical conical volume is removed from the spherical conical volume. A spherical cone, also referred to as a spherical sector, is a portion of a sphere defined by a conical boundary with an apex (i.e., the point of the spherical cone) at the center of the sphere. A spherical cone is the union of a spherical cap and a cone formed by the center of the sphere and the base of the cap. The RPS may utilize a simplified off-chip mechanical gimbal (i.e., a rotatable structure) and can increase the field of view accessible to light emitted from or received by a photonic array.

Some of the example RPSs described herein comprise a photonic array with a receiving aperture (e.g., a receiving photonic array, a receiving portion, or a receiving subsystem) and a transmitting aperture (e.g., a transmitting photonic array, a transmitting portion, or a transmitting subsystem). An RPS may comprise separate structures (e.g., in bistatic arrangements), where the transmitting aperture and receiving aperture are not physically connected together, or are fabricated as stand-alone devices. In other examples, the transmitting aperture and the receiving aperture of the RPS may be the same (e.g., in monostatic arrangements).

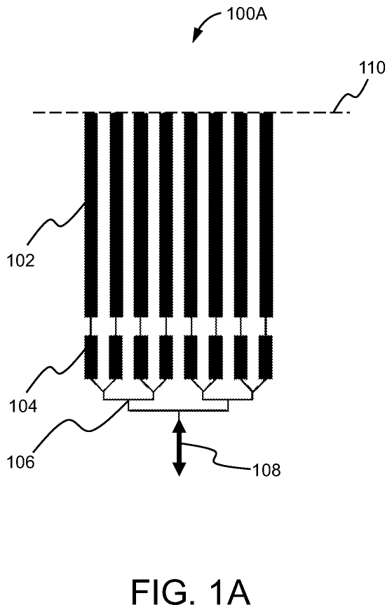

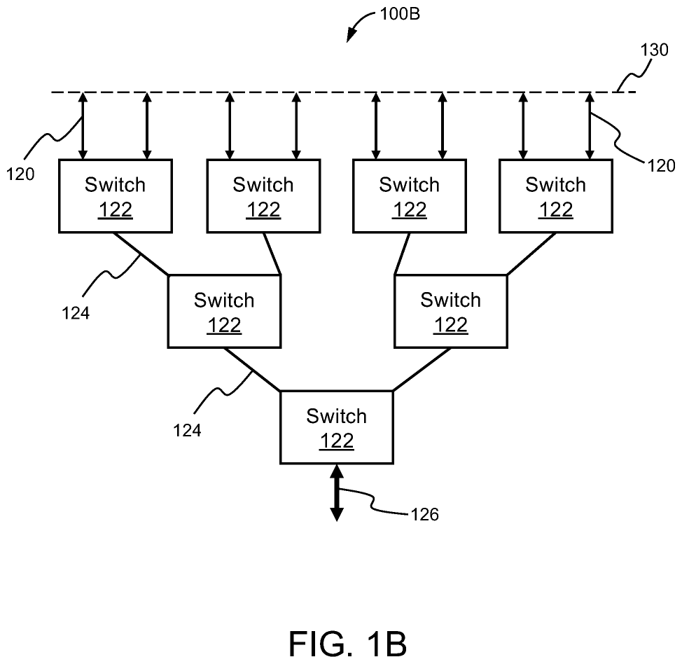

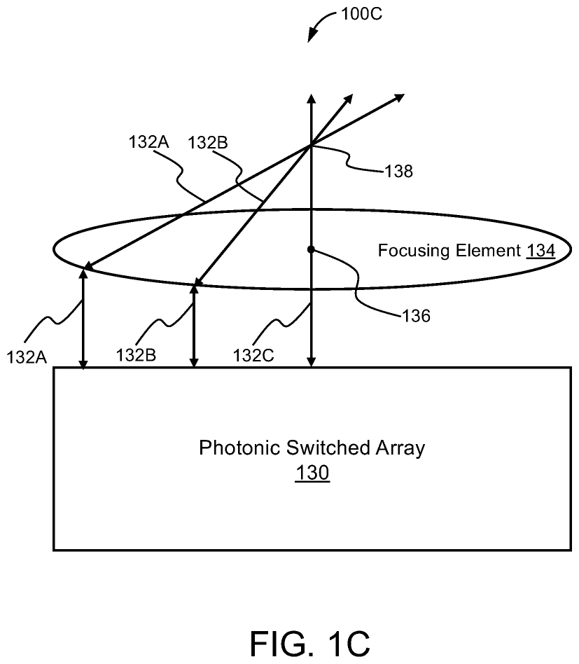

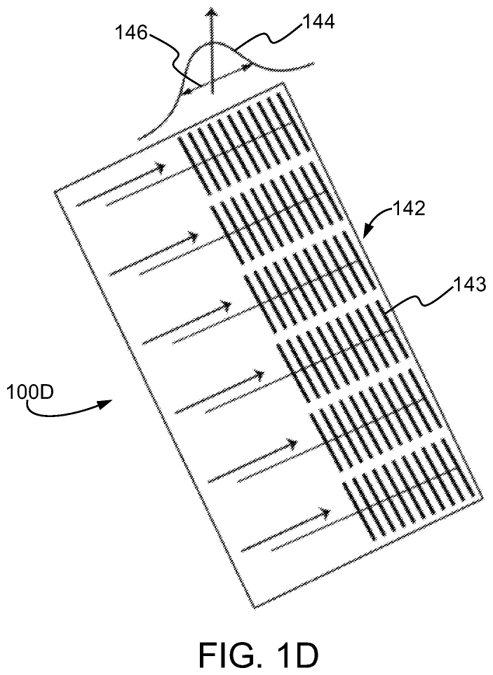

FIG. 1A shows an example optical phased array 100A comprising an array of optical antennas 102. The optical antennas 102 may, for example, be optical gratings (also referred to as grating couplers) or waveguide facets (also referred to as an “end-fire” configuration). In an example that uses an end-fire configuration, light is transmitted from or received into the optical antennas 102 at facets distributed over an edge 110 along which the optical antennas 102 are arranged. Similarly, with grating-based optical antennas, light can be transmitted from or received into grating couplers distributed over a line along which the optical antennas are arranged. The optical phased array 100A further comprises an array of phase shifters 104 which can be, for example, thermal phase shifters, electro-optic phase shifters, and/or microelectromechanical phase shifters. In some examples, each of the phase shifters 104 may be controlled independently, while in other examples two or more of the phase shifters 104 may be jointly controlled. The phase shifters 104 may modulate the direction and radiation intensity pattern (i.e., the gain pattern) associated with one or more beams emitted from or received by the optical phased array 100A. Optical power splitters 106 optically couple an optical port 108 to each of the phase shifters 104 that are optically coupled to respective optical antennas 102. In this example, the power splitters 106 are connected by waveguides in a binary tree arrangement, though in general, non-binary tree arrangements may be used. Light received by the optical antennas 102 can thus be merged into an output optical signal at the optical port 108 which can then be further manipulated, transformed, or measured. In the reverse direction, an input optical signal provided at the optical port 108 can be coupled to and emitted from the optical antennas 102.

In some implementations, the examples described herein may be designed to operate over a determined range of optical wavelengths, for example, the λ=1500 to 1600 nm band or the λ=1270 to 1330 nm band, and the base spacing pitch a between optical antennas may be of similar magnitude to the optical wavelength. For example, for operation in the 1500 to 1600 nm band, 700 nm≤a≤4000 nm may be typical.

FIG. 1B shows a photonic switched array 100B comprising an array of optical antennas 120 (e.g., waveguide facets in an end-fire configuration, optical gratings, plasmonic emitters, metal antennas, and mirror facets). The photonic switched array 100B is arranged in a tree-like structure comprising a plurality of optical switches 122 (e.g., Mach-Zehnder interferometers) and optically interconnected via waveguides 124. The optical switches 122 may be controlled in response to one or more applied voltages, allowing the optical switches 122 to direct light at a first switch port to a second switch port and a third switch port in a tunable ratio (e.g., 50/50, 0/100, 25/75). Accordingly, the tree of optical switches 122 can be configured (e.g., by applied voltages) to open select optical pathways between an optical port 126 and the array of optical antennas 120. For example, by applying suitable (possibly time-varying) voltages, the photonic switched array 100B can provide light (e.g., emitted from a laser) from the optical port 126 to one or more of the optical antennas 120. In another example, by applying suitable voltages, the photonic switched array 100B can provide light received by one or more of the optical antennas 120 to the optical port 126. In an example that uses an end-fire configuration, light is transmitted from or received into the optical antennas 120 at facets distributed over an edge 130 along which the optical antennas 120 are arranged. In general, the optical switches 122 may have slightly different voltage requirements for power switching between their ports. Furthermore, one or more of the optical switches 122 may be electrically interconnected to allow for joint voltage control, possibly reducing the number of voltage sources used.

Referring again to FIG. 1B, the optical switches 122 are configured in a 1×2 arrangement, however, other arrangements (e.g., 1×3, 1×4, 2×2, or 2×3) and mixtures of arrangements may also be utilized. The one or more switch types in a photonic switched array need not all be of the same type or of the same technology (e.g., thermo-optic or electro-optic switches). A portion or all of the photonic switched array 100B may by formed as part of a PIC.

FIG. 1C shows an example photonic switched array system 100C that performs 1D-beam-steering. A photonic switched array 130 (e.g., the photonic switched array 100B shown in FIG. 1B) can selectively output a first optical beam 132A, a second optical beam 132B, and/or a third optical beam 132C. In general, the photonic switched array 130 can output many optical beams. Each optical beam traverses a focusing element 134 (e.g., a lens) that converts a lateral displacement between the optical beam and a center of the focusing element 136 into an angular displacement. In this example, each optical beam orthogonal to the surface of the focusing element 136 intersects at a point 138 (e.g., a focus of a lens). For example, the first optical beam 132A has a larger lateral displacement from the center of the focusing element 136 than the second optical beam 132B, resulting in the first optical beam 132A having a larger angular displacement (with respect to its optical path prior to traversing the focusing element 134) than the second optical beam 132B. Since the third optical beam 132C is orthogonal to the surface of the focusing element 134 and has no lateral displacement from the center of the focusing element 136, the third optical beam 132C has no angular displacement.

FIG. 1D shows a portion of an example grating antenna array 100D comprising grating antennas 142 that are configured to emit an output beam with an intensity profile 144 in a direction substantially perpendicular to the grating antenna array 100D. The grating antennas 142 comprise grating elements 143 (also referred to as grating teeth) distributed along their propagation axis that perturb a guided mode as it propagates along the length of the grating antenna, causing light to be emitted in a direction (e.g., substantially perpendicular) that depends on the period of the grating elements 143 and on the wavelength of the light. Similarly, light can be received into the grating antennas 142 preferentially from a direction that depends on the period of the grating elements 143 and on the wavelength of the light. The grating antenna array 100D can be modified such that a total length of the grating antennas 142 and an effective aperture size 146 is suited to a desired beam divergence angle.

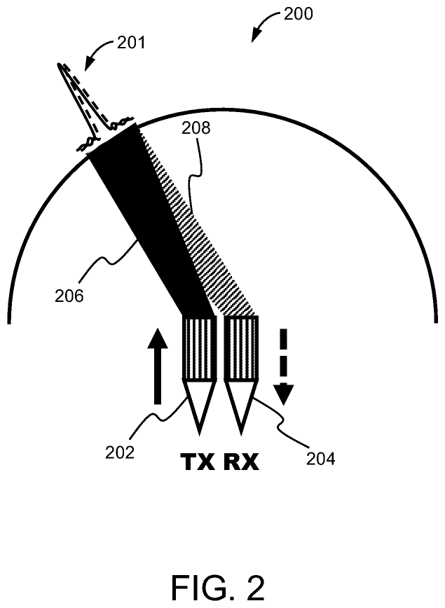

FIG. 2 shows an example photonic array transceiver system 200 comprising radiation intensity patterns 201 associated with a transmitter photonic array 202 (solid line) and a receiver photonic array 204 (dashed line). A transmitter main lobe 206 and a receiver main lobe 208 overlap. Such an arrangement of lobe overlaps can result, for example, from tuning phase shifters associated with transmitter and receiving optical antennas in an optical phased array, or by applying suitable voltages to one or more optical switches in a photonic switched array. In general, one or more beams emitted or received from a photonic array within a transceiver can be steered using reflective, dispersive, and/or refractive structures, for example. A return signal from an object situated near the main lobes is received by the receiver photonic array 204.

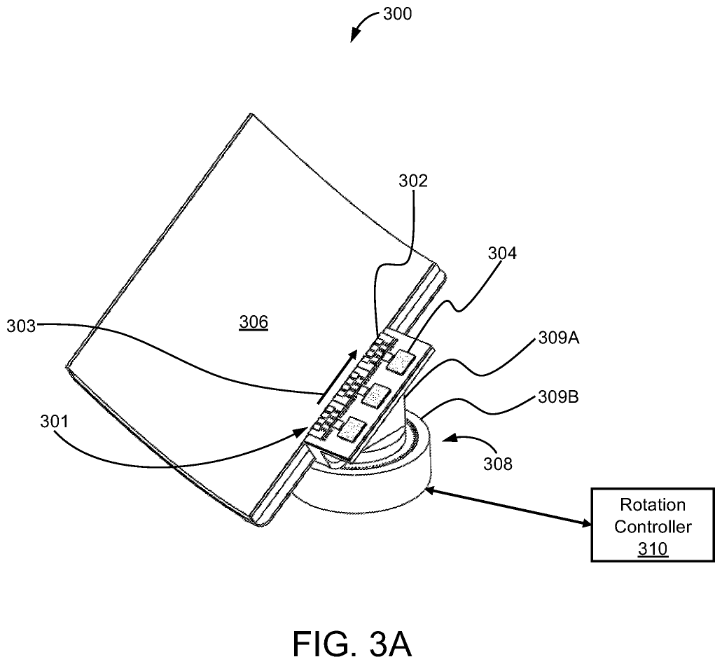

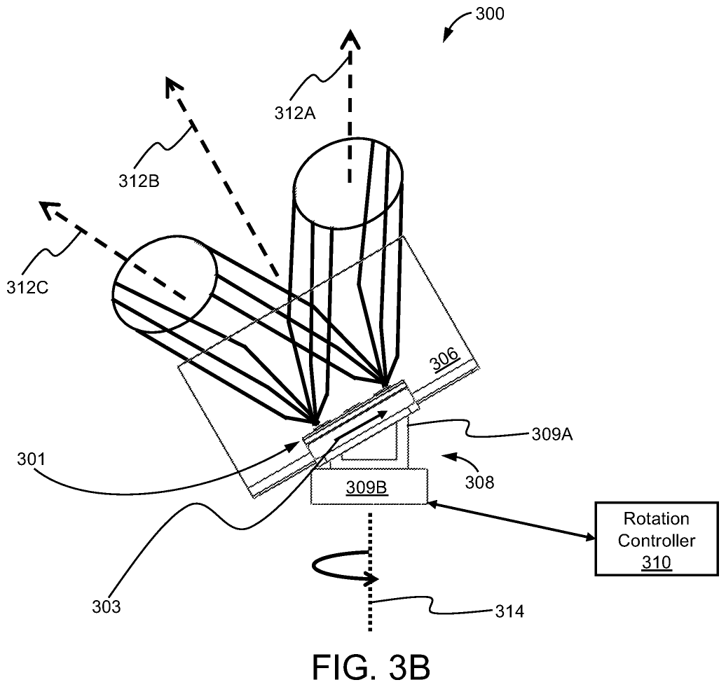

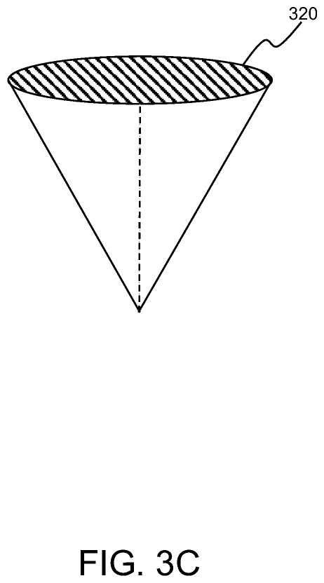

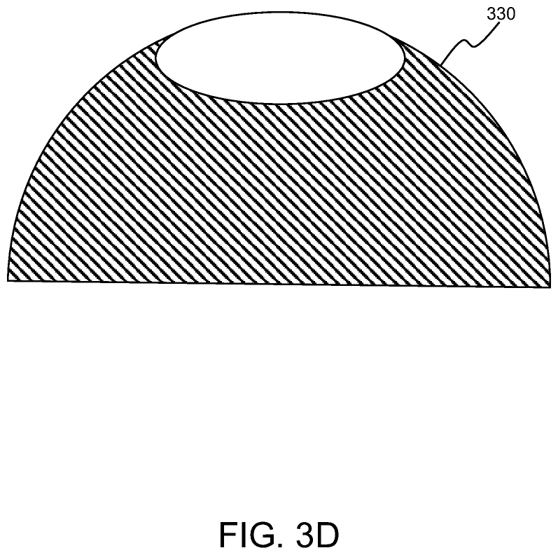

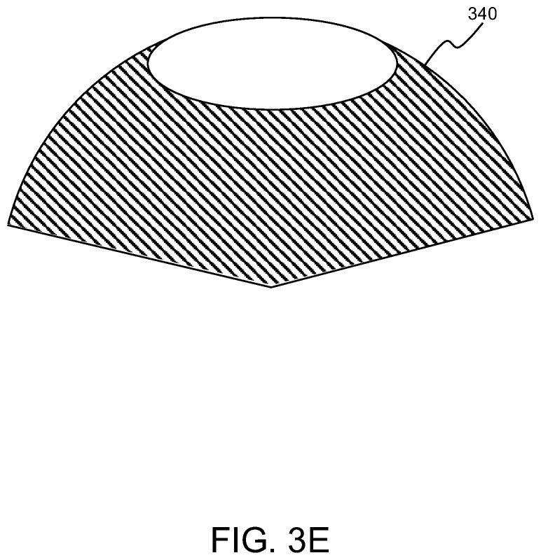

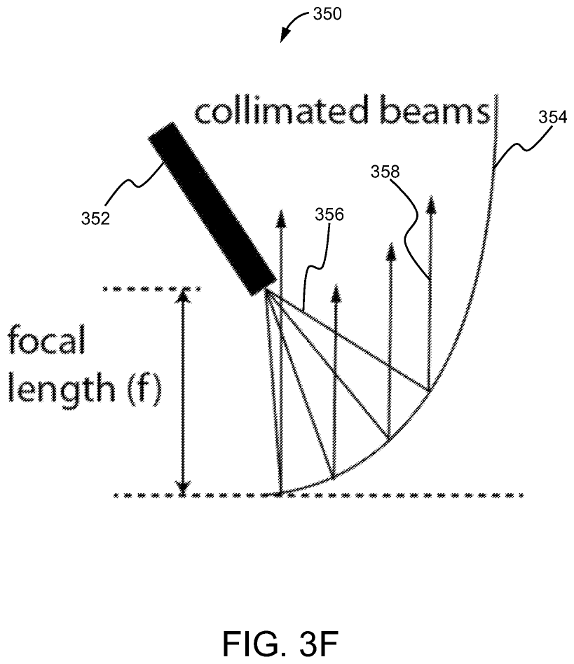

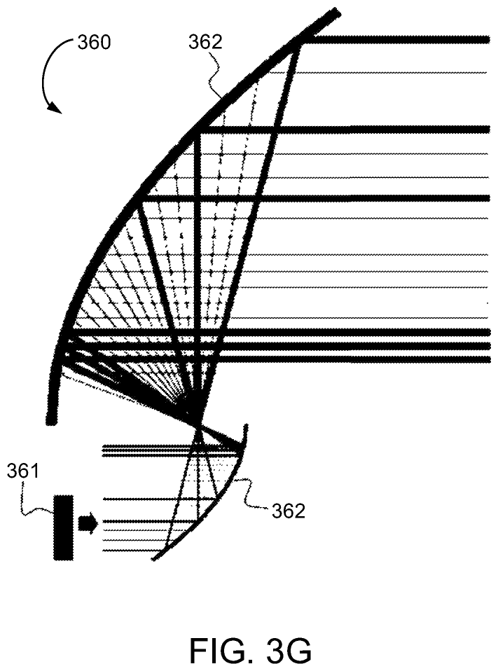

FIG. 3A shows a first view of an example RPS 300 that includes a PIC 301 comprising photonic arrays 302 configured to collectively provide optical antennas that are arranged along a line referred to herein as an array direction 303. In this example, different sets of the photonic arrays 302 are controlled by different respective controllers 304. The photonic arrays 302 comprise optical antennas that emit light that is then reflected off a reflecting optical element 306. The photonic arrays 302, the controllers 304, and the reflecting optical element 306 together form an electronically steerable optical source. In other examples, an electronically steerable optical source can be formed without requiring a reflecting optical element, such as with photonic arrays that comprise grating antennas, such as those describe with reference to FIG. 1D. In this example, the reflecting optical element 306 also modifies the steering axis about which the 1D beam steering occurs, as described in more detail below with reference to FIG. 3B.

The electronically steerable optical source is rigidly mounted on a rotatable gimbal 308 that includes a mounting structure 309A and a base structure 309B on which the mounting structure 309A is rotatably attached. The rotatable gimbal 308 is able to rotate the mounting structure 309A with respect to the base structure 309B about an axis (e.g., an axis that intersects the center of the base structure 309B and that is perpendicular to the bottom surface of the base structure 309B), in some examples by at least 360°, or by at least 180°. In such an arrangement, 2D-beam-steering can be performed by utilizing non-mechanical beam steering (e.g., electronic steering using the photonic arrays 302) about a first axis perpendicular to the array direction 303, and mechanical beam steering about a second axis using the rotatable gimbal 308. A rotation controller 310 is in communication with the rotatable gimbal 308 and controls the rotation of the rotatable gimbal 308. The rotation controller 310 may comprise, for example, one or more central processing units, application-specific integrated circuits, or field-programmable gate arrays. In this example, the rotation controller 310 is located external to the rotatable gimbal 308. In other examples, the rotation controller 310 can be partially or wholly located within the rotatable gimbal 308 (e.g., inside of the mounting structure 309A, inside of the base structure 309B, or inside of both). The rotation controller 310 may be preprogrammed to execute specified rotations, or it may receive additional communications (e.g., from a computing system) that comprise instructions for rotations.

Referring again to FIG. 3A, the RPS 300 provides non-mechanical, electronic (e.g., solid-state) beam steering along one dimension using a low mass, compact optical aperture with low inertia. To enable 2D-beam-steering, the photonic arrays 302 are located upon the rotatable gimbal 308. Due to the low payload inertia on the rotatable gimbal 308, the power consumption to drive the rotatable gimbal 308 may be relatively small. These features may enable the RPS 300 to be a low size, weight, and power (SWaP) 2D-beam-steerer. In this example, the photonic arrays 302 are in an end-fire configuration, with optical antenna waveguides emitting light at the facet of the one or more photonic chips in which the photonic arrays 302 are fabricated. In other examples, the RPS 300 can be implemented using other implementations of photonic arrays 302 (e.g., out-of-plane grating-based optical antennas). Additionally, the RPS 300 may be used for transmit (TX) photonic arrays, receive (RX) photonic arrays, monostatic (simultaneous TX/RX) photonic arrays, or bistatic (separate TX and RX) photonic arrays.

Referring again to FIG. 3A, in some examples, the photonic arrays 302 are optical phased arrays (e.g., the optical phased array 100A shown in FIG. 1A), such that light emitted from the optical antennas of the optical phased arrays interferes to form a beam. By altering the phase shifters associated with each optical antenna, 1D-beam-steering occurs about an axis that is perpendicular to the array direction 303. The light emitted by optical phased arrays is typically collimated along a first collimation axis parallel to the array direction 303 along which the optical antennas of the optical phased arrays are arranged. The light emitted may then be collimated along a second collimation axis, perpendicular to the first collimation axis, through the use of a reflecting cylindrical optic as the reflecting optical element 306, which can eliminate the need for a possibly large telescope.

Referring again to FIG. 3A, in some examples, the photonic arrays 302 are photonic switched arrays (e.g., the photonic switched array 100B shown in FIG. 1B), such that light may be selectively emitted from one or more of the optical antennas of the photonic switched arrays. By applying suitable voltages to optical switches associated with each optical antenna, 1D-beam-steering occurs about an axis that is perpendicular to the array direction 303 and perpendicular to the plane of the chip on which the photonic arrays 302 are formed. In some examples, a focusing element (not shown) may be placed between the photonic arrays 302 and the reflecting optical element 306, so as to form a photonic switched array system (e.g., the photonic switched array system 100C shown in FIG. 1C). The light emitted by photonic switched arrays is typically collimated along a first collimation axis parallel to the array direction 303 along which the optical antennas of the optical switched arrays are arranged. The light emitted may then be collimated along a second collimation axis, perpendicular to the first collimation axis, through the use of a reflecting cylindrical optic as the reflecting optical element 306. In some examples, the reflecting optical element 306 may be designed, for example, with a non-cylindrical shape (e.g., with curvature along two orthogonal axes of the reflecting optical element 306), so as to enable the photonic switched arrays to operate without an additional focusing element placed between the photonic arrays 302 and the reflecting optical element 306, or after the reflecting optical element 306.

FIG. 3B shows a second view of the RPS 300 shown in FIG. 3A. The modified 1D-beam-steering range of the beam reflected from the reflecting optical element 306 corresponds to a modified 1D field of view and includes a center vector 312B that is in the center of the modified 1D-beam-steering range. The PIC 301 is located on the rotatable gimbal 308 so as to increase the field of view from a 1D field of view to a 2D field of view as the rotatable gimbal 308 is rotated. In this example, the PIC 301 and reflecting optical element 306 are oriented such that a first vector 312A defining a first end of the steering range corresponding to the modified 1D field of view is oriented along (i.e., substantially parallel to) the vertical direction. The modified 1D-beam-steering occurs about a modified steering axis (not shown) that is into the page in the view of FIG. 3B, which is still perpendicular to the array direction 303. A second vector 312C defining a second end of the modified 1D-beam-steering range corresponding to the modified 1D field of view is at an angular separation from the center vector 312B that is equal to the angle between the vector 312A and the center vector 312B. The rotatable gimbal 308 is able to rotate about a gimbal axis 314 that intersects the center of the base structure 309B and that is perpendicular to the bottom surface of the base 309B structure. In some examples, the PIC 301 can perform 1D-beam-steering of ±45° degrees relative to the center vector 312B. In such examples, when combined with 360° rotation from the rotatable gimbal 308, the RPS 300 can emit and receive light over an entire hemisphere field of view, where the spherical cap of the hemisphere defining its volume is determined by the distance range over which the light has sufficient power to operate. In general, the 2D-beam-steering performed by the RPS 300 may have a field of view that is a portion of the volume of an entire hemisphere. For example, the 2D-beam-steering may cover a conical volume (e.g., the field of view 320 shown in FIG. 3C), or it may cover a portion of the volume of an entire hemisphere, wherein a spherical conical volume is removed from the hemisphere (e.g., the field of view 330 shown in FIG. 3D). Furthermore, the 2D-beam-steering may cover a portion of a spherical conical volume, wherein a smaller spherical conical volume is removed from the spherical conical volume (e.g., the field of view 340 shown in FIG. 3E). A spherical cone, as described previously, is a portion of a sphere defined by a conical boundary with an apex at the center of the sphere.

FIG. 3C shows an example field of view 320 covering a conical volume. The field of view 300C is represented by the patterned region.

FIG. 3D shows an example field of view 330 covering a portion of the volume of an entire hemisphere, wherein a spherical conical volume is removed from the hemisphere. The field of view 300D is represented by the patterned region.

FIG. 3E shows an example field of view 340 covering a portion of a spherical conical volume, wherein a smaller spherical conical volume is removed from the spherical conical volume. The field of view 300E is represented by the patterned region.

FIG. 3F shows an example collimation configuration 350 (e.g., as may be used in the RPS 300 shown in FIGS. 3A and 3B), comprising an array of optical antennas 352 arranged in a row that extends into and out of the page. A reflecting optical element 354 collimates diverging rays 356 into parallel rays 358.

An optical beam emitted from a waveguide mode undergoes divergence in a plane that is perpendicular to the linear array of antennas according to the divergence of a single antenna, and thus may diverge quickly in that plane. The rate of divergence, also measured by the mode cone angle, depends on the mode size and therefore can depend on the effective aperture size of an end-fire antenna. The control of the mode and the associated beam divergence can be performed by any of a variety of techniques. In some examples, it is desirable to emit a relatively collimated beam such that after emission the light can be magnified to expand the transverse size of the beam, without increasing divergence, by using two focusing elements (e.g., a telescope) in order to create a larger effective aperture for either transmitting or receiving. This expansion by magnification may also change the diffraction angle with the inverse of the magnification ratio of the aperture size. Therefore, by first emitting a collimated beam, the output beam will remain collimated after the two focusing elements, as explained in more detail below. One method to reduce the beam divergence is by increasing the beam size formed by an array of grating antennas. For example, the strength of a grating antenna array can be adjusted in a way such that the total length of the grating antennas and the corresponding effective aperture size is suited to the desired beam divergence angle (e.g., as shown in FIG. 1D).

The techniques described above can increase the effective aperture size from submicrometric scale to several micrometers. Nevertheless, the transverse mode size of the beam may still increase faster along a first direction than along a second direction. One technique to overcome the residual divergence of the beam is by utilizing a focusing element with collimating power in the desired direction.

In some examples, the emitting aperture of a photonic array is limited by the reticle size, which is a direct function of a fabrication process (e.g., the field size of a lithography stepper, which may have an area of approximately 26 mm×30 mm). An example constraint for a single photonic array may be that it is as large as the full reticle. In some implementations, an external optical beam expander can be used to increase the beam size out of the photonic arrays by a beam expansion ratio. Such expansion allows for the use of smaller and more compact photonic arrays that still achieve a large aperture size, as well as the ability to increase the beam size beyond the full reticle. In examples where the photonic arrays comprise grating-based optical antennas (e.g., composed of grating couplers, also referred to as grating emitters), the beam expander described herein allows for the use of smaller grating antennas and for an increase in the beam size external to the photonic array. This may allow much shorter grating antennas to be fabricated, which ultimately may produce a more uniform beam. Examples of advantages that can result from using such a beam expander include: (1) PIC/optical component alignment sensitivity is reduced significantly compared to other beam expansion methods for photonic arrays, (2) a larger beam size is possible without having to make larger antennas or photonic dies and without aperture stitching, and (3) shorter antennas with post-PIC (i.e., external to the PIC) beam expansion allow for a more uniform beam quality.

FIG. 3G shows an example beam expansion configuration 360 for expanding a beam from a photonic array 361, which may include one or more external optical elements. The photonic array 361 provides a substantially collimated beam to a beam expander that includes two off-axis parabola-shaped reflective optical components 362. Two different off-axis angles and beam expansion ratios for two different beams (shown by the thicker lines) are shown. In this example, the photonic array 361 has a surface emitting configuration where a collimated or limited divergence beam is formed by light that is gradually emitted over the lengths of an array of antennas that emit approximately perpendicular to the surface of the photonic array 361. In other examples, the photonic array 361 can have an end-fire configuration where a collimated or limited divergence beam is formed by light that is emitted from the ends of an array of antennas that emit from an edge of the photonic array 361. In other examples, the optical components 362 of the beam expander can be implemented using focusing elements (e.g., mirrors or lenses) configured to expand the beam. In general, reflective, refractive, or a combination of reflective and refractive beam expanders can be implemented.

A reflective beam expander, where two or more focusing elements are implemented using a reflective surface (e.g., a curved mirror), may have several advantages compared to transmissive surfaces (e.g., in a refractive beam expander). For example, reflective focusing elements do not have glass through which the beam propagates, and thus do not have chromatic aberrations. Furthermore, there are no element thickness or glass-specific tolerances, and there is no coupling between the x-axis and the y-axis when steering a beam. Alternatively, in a refractive beam expander, two or more focusing elements can be implemented using a refractive element (e.g., a lens or a compound multi-element lens system). In other examples, a combination beam expander can use at least one reflective focusing element and at least one refractive focusing element in a telescopic arrangement. In any of the previously described beam expanders, the first and second focusing elements can have different effective focal lengths so as to magnify a beam from a relatively small transverse size to or from a photonic array to a relatively large transverse size of a beam that is substantially collimated (e.g., for propagation over a relatively long distance to or from the photonic array).

In some examples (e.g., free-space optical communication), an optical beacon may be used to lock separate TX (transmitter) and RX (receiver) modules in a communication link.

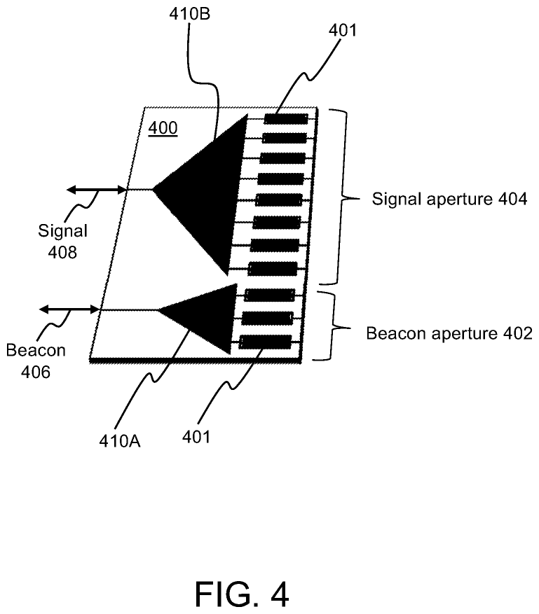

FIG. 4 shows an example PIC 400 comprising optical antennas 401, as well as a beacon aperture 402 adjacent to a signal aperture 404. The beacon aperture 402 can utilize a wavelength that is different from the wavelength used by the signal aperture 404 and may also use any external collimating optics (e.g., the reflecting optical element 306 shown in FIGS. 3A and 3B) that the signal aperture 404 is utilizing. The PIC 400 further comprises an optical beacon port 406 and an optical signal port 408 that are respectively optically coupled to the beacon aperture 402 and the signal aperture 404 by waveguides and by the optical antennas 401. A first optical multiplexer 410A divides or combines light traveling between the optical antennas 401 and the optical beacon port 406, and a second optical multiplexer 410B divides or combines light traveling between the optical antennas 401 and the optical signal port 408. In some examples, the first optical multiplexer 410A and the second optical multiplexer 410B can behave as optical switches, such that the PIC 400 may function as a photonic switched array. In other examples (e.g., not comprising optical switches), the PIC 400 may function as an optical phased array.

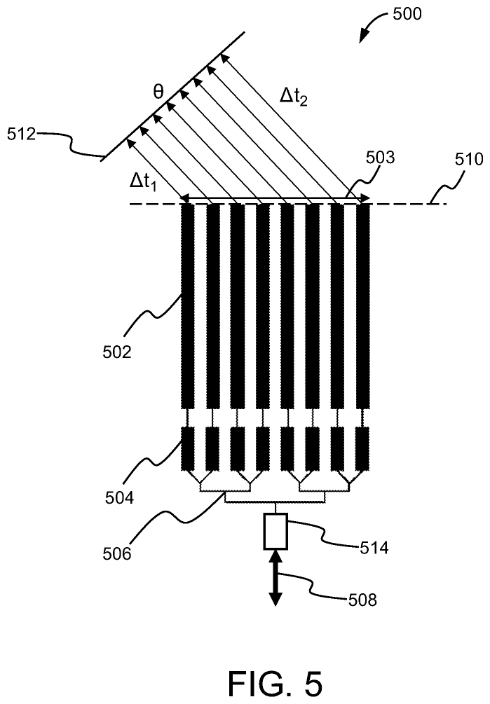

FIG. 5 shows an example optical phased array 500 comprising an array of optical antennas 502 that emit light through an aperture 503. In this example, an end-fire configuration is utilized such that light is transmitted from or received into the optical antennas 502 at facets distributed over an edge 510 along which the optical antennas 502 are arranged. The optical phased array 500 further comprises an array of phase shifters 504. Optical power splitters 506 optically couple an optical port 508 to each of the phase shifters 504 that are optically coupled to respective optical antennas 502. In this example, the power splitters 506 are connected by waveguides in a binary tree arrangement, though in general, non-binary tree arrangements may be used. Light emitted from the left end of the optical phased array 500 takes a time Δt₁ to reach a plane 512, while light emitted from the right end of the optical phased array 500 takes a time Δt₂ to reach the plane 512. A modulator 514 (e.g., an electro-optic modulator) can encode information into the light emitted from the optical phased array 500 (e.g., for free-space optical communications) by modifying a phase, frequency, amplitude, or polarization associated with the light. The time delay (e.g., Δt₂−Δt₁) between different elements to the plane 512 (in some cases, the waist of the beam) varies as a function of the steering angle θ and may be significant, especially for large steering angles. For high data-rates (e.g., tens of GHz data signals), the varying time delays may result in symbol interference (also referred to as “squint”).

In order to reduce the effects of such time delays, one solution is to utilize tunable (e.g., as a function of the steering angle) optical time delays for certain groups of optical antennas, as may be done with true time delay elements (that may produce phase shifts greater than 2π) in a photonic array. Another option to reduce the effects of time delays is to use more than one modulator. In some examples, each optical antenna may have its own modulator associated with it, while in other examples, groups of optical antennas may have their own modulator associated with the group. The inputs that encode data to be optically communicated by the modulators may have a tunable delay to mimic the optical delay. In some examples, these two methods to reduce the effects of time delays are physically identical with respect to the beam formed by the optical phased array.

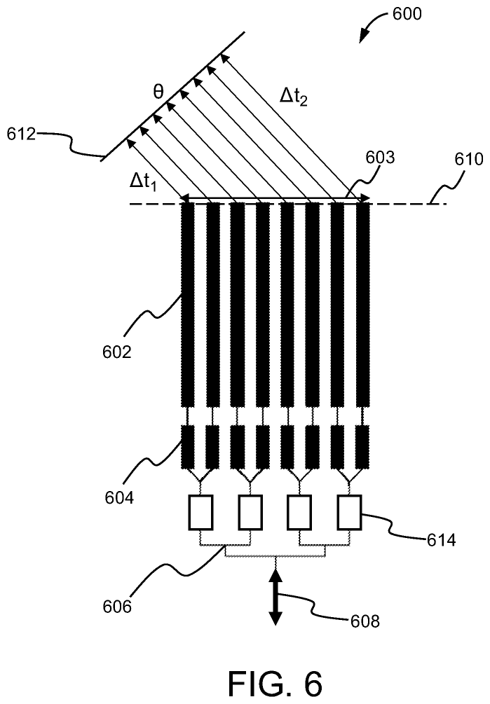

FIG. 6 shows an example optical phased array 600 comprising an array of optical antennas 602 that emit light through an aperture 603. In this example, an end-fire configuration is utilized such that light is transmitted from or received into the optical antennas 602 at facets distributed over an edge 610 along which the optical antennas 602 are arranged. The optical phased array 600 further comprises an array of phase shifters 604. Optical power splitters 606 optically couple an optical port 608 to each of the phase shifters 604 that are optically coupled to respective optical antennas 602. Light emitted from the left end of the optical phased array 600 takes a time Δt₁ to reach a plane 612, while light emitted from the right end of the optical phased array 600 takes a time Δt₂ to reach the plane 612. In this example, the optical phased array 600 comprises several modulators 614 each associated with two optical antennas 602. The output (e.g., the timing or frequency) of each modulator 614 may adjust for time delays between optical antennas 602 across the optical phased array 600 to reduce “squint” and increase data transmission fidelity. The output of each modulator 614 may depend on an aperture 603, a wavelength of light emitted by the optical phased array 600, and/or the beam steering angle θ.

In some examples, an RPS can be configured to receive both S and P polarizations of light in a free-space data link (e.g., due to atmospheric effects or due to the different rotations of the TX and RX modules). For example, 1D-beam-steering can be implemented with polarization diversity (e.g., two separate 1D-beam-steerers, one optimized for S polarization and one optimized for P polarization), that, when combined with a 360° rotatable gimbal, may be used as a polarization insensitive transceiver over a full hemisphere field of view.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An apparatus comprising:
an electronically steerable optical source comprising
a photonic array comprising a plurality of optical antennas arranged along a line, and
circuitry configured to control steering of a beam transmitted from or received by one or more of the optical antennas about a first axis, where (1) the first axis is substantially perpendicular to the line, and (2) a steering range over which the steering of the beam is limited is characterized by a first vector at one extremum of the steering range and a second vector at another extremum of the steering range;
a base structure;
a mounting structure rotatably attached to the base structure, with the electronically steerable optical source rigidly mounted to the mounting structure; and
a rotation controller configured to rotate the mounting structure with respect to the base structure about a second axis by at least 180 degrees, where the electronically steerable optical source is oriented on the mounting structure such that (1) the second axis is not parallel to the line, and (2) the first vector is substantially parallel to the second axis.

2. The apparatus of claim 1, further comprising an optical element configured to transfer the beam to or from one or more of the optical antennas and configured to at least partially collimate the beam.

3. The apparatus of claim 2, wherein the optical element comprises one or more reflective curved surfaces configured to collimate the beam.

4. The apparatus of claim 3, wherein the collimating occurs along a first direction associated with the beam.

5. The apparatus of claim 4, wherein the collimating also occurs along a second direction perpendicular to the first direction associated with the beam.

6. The apparatus of claim 4, wherein the optical element is cylindrical and the collimating occurs only along the first direction associated with the beam.

7. The apparatus of claim 1, wherein the photonic array is an optical phased array.

8. The apparatus of claim 7, wherein the circuitry configured to control steering of the beam comprises one or more phase shifters.

9. The apparatus of claim 8, wherein the one or more phase shifters are voltage-controlled.

10. The apparatus of claim 7, wherein the electronically steerable optical source further comprises two or more modulators, each associated with a different subset of one or more of the optical antennas, configured to encode information in the beam based at least in part on one or more of: a wavelength of the beam, an aperture size associated with the optical phased array, or an angle of steering of the beam about the first axis.

11. The apparatus of claim 10, wherein the two or more modulators are each configured to encode information in the beam by modifying at least one of a phase, frequency, amplitude, or polarization associated with the beam.

12. The apparatus of claim 1, wherein the optical antennas comprise grating antennas on a photonic integrated circuit.

13. The apparatus of claim 1, wherein the optical antennas comprise portions of at least one facet of a photonic integrated circuit, and each portion is coupled to a respective waveguide in the photonic integrated circuit.

14. The apparatus of claim 1, wherein the photonic array is a photonic switched array, and the circuitry configured to control steering of a beam transmitted from or received by one or more of the optical antennas comprises one or more optical switches.

15. The apparatus of claim 14, wherein the one or more optical switches are voltage-controlled.

16. The apparatus of claim 14, wherein the optical switches are configured to optically couple a subset of the optical antennas and an optical port of the photonic switched array.

17. The apparatus of claim 14, further comprising an optical steering element configured to convert a lateral displacement between the beam and a center of the optical steering element into an angular displacement.

18. The apparatus of claim 17, wherein the optical steering element is further configured to collimate the beam.

19. The apparatus of claim 1, further comprising a first optical element and a second optical element configured to expand the beam.

20. The apparatus of claim 1, wherein the rotation controller is configured to rotate the mounting structure with respect to the base structure about the second axis by at least 360 degrees.

21. A method for steering a beam transmitted from or received by one or more optical antennas of a plurality of optical antennas, of at least one photonic array, arranged along a line, the method comprising:
controlling steering of the beam about a first axis based on electronic control of the photonic array, wherein
the first axis is substantially perpendicular to the line, and
a steering range over which the steering of the beam is limited is characterized by a first vector at one extremum of the steering range and a second vector at another extremum of the steering range; and
controlling steering of the beam about a second axis based on rotation of a mounting structure on which an electronically steerable optical source comprising the photonic array is rigidly attached, wherein
the mounting structure defines a second axis,
the electronically steerable optical source is oriented on the mounting structure such that (1) the second axis is not parallel to the line, and (2) the first vector is substantially parallel to the second axis, and
the mounting structure is rotated with respect to a base on which the mounting structure is rotatably attached about the second axis by at least 180 degrees.
